(19) United States
(12) Patent Application Publication
(10) Pub. No.: US 2017/0121430 A1
(43) Pub. Date: May 4, 2017

(54) Ziegler-Natta Catalyst Composition And A Process For Its Preparation

(71) Applicant: Reliance Industries Limited, Mumbai (IN)

(72) Inventors: Virendrakumar Gupta, Navi Mumbai (IN); Yogeshwar Narayanrao Thakare, Amravati (IN); Bhavesh Kiritbhai Desai, Guntur (IN); Suketu Vakil, Dadar, Mumbail (IN)

(21) Appl. No.: 15/311,973

(22) PCT Filed: May 20, 2015
(86) PCT No.: PCT/IB2015/053701

§ 371 Date: Nov. 17, 2016

(30) Foreign Application Priority Data
May 20, 2014 (IN) 1695/MUM/2014

(51) Int. Cl. C08F 110/06

(52) U.S. Cl. CPC C08F 110/06

(57) ABSTRACT

The present disclosure relates to a Ziegler-Natta catalyst composition comprising: i. at least one pro-catalyst comprising: a morphologically modified magnesium alkoxide as a support; at least one titanium halide; at least one first internal donor and at least one second internal donor; and at least one inert hydrocarbon medium, ii. at least one organo-aluminum compound as a co-catalyst; and iii. at least one external donor comprising an organo-silane compound and a carboxylic acid ester. The present disclosure also relates to a process for the preparation of the Ziegler-Natta catalyst composition.

### FIELD OF THE DISCLOSURE

The present disclosure relates to a Ziegler-Natta catalyst composition and a process for its preparation.

### BACKGROUND

Ziegler-Natta catalysts are employed in the production of polyolefins having varied molecular weight and stereoregularity. Ziegler-Natta catalysts typically consist of pro-catalysts, co-catalysts and electron donors. The pro-catalyst is activated by a co-catalyst for a polymerization reaction whereas electron donors control the polymerization rate and the morphology of the polyolefin resins by controlling stereo-selectivity of the catalyst.

However, most of existing Ziegler-Natta catalysts show inadequate control on polymerization kinetics which results in the generation of polymer chunks usually referred to as low particle size resins or fines thereby choking equipment such as cycle gas compressors.

Several attempts were made to improve the control of the Ziegler-Natta catalyst composition on polymerization reaction kinetics using different combinations of pro-catalysts, co-catalysts and electron donors.

U.S. Pat. No. 6,395,670 mentions a catalyst for the polymerization of olefins. The catalyst comprises anhydrous magnesium dichloride, titanium compound and electron donors. U.S. Pat. No. 6,395,670 also mentions the use of at least two electron donors in combination with anhydrous magnesium dichloride and titanium compound. The electron donors used in U.S. Pat. No. 6,395,670 include a compound containing two or more ether and/or ester groups.

Another patent U.S. Pat. No. 6,468,938 provides pre-polymerized catalyst components for co-polymerization of olefins CH₂HR. The catalyst components disclosed by U.S. Pat. No. 6,468,938 contain Ti, Mg, halogen and an electron donor compound.

Further, U.S. Pat. No. 8,222,357 describes a pro-catalyst containing a multiple internal electron donor with at least two components, one of which is a silyl ester. Other components of the mixed internal electron donor include aromatic acid ester, di-ether and combinations thereof.

US20110054129 mentions a process for the synthesis of magnesium alkoxide by reacting magnesium metal and alcohol in the presence of iodine. The magnesium alkoxide particles synthesized by the aforementioned method are frangible and do not retain their morphology or particle size during the synthesis of the Ziegler Natta pro-catalyst.

However, these Ziegler-Natta catalysts show lack of control on reaction kinetics during polymerization reactions which leads to development of polymer chunks in the reaction mass. Also, they show less hydrogen response.

Therefore, there exists a need for a Ziegler-Natta catalyst composition having high hydrogen response, better control over polymerization kinetics to avoid development of polymer chunks and to produce a polymer having the desired particle size distribution.

Objects

Some of the objects of the present disclosure, which at least one embodiment is able to achieve, are discussed herein below.

It is an object of the present disclosure to provide a novel Ziegler-Natta catalyst composition.

It is another object of the present disclosure to provide a Ziegler-Natta catalyst composition capable of controlling reaction kinetics of an olefin polymerization reaction.

It is still another object of the present disclosure to provide a Ziegler-Natta catalyst composition with the desired activity and hydrogen response.

It is yet another object of the present disclosure to provide a Ziegler-Natta catalyst composition which can be used for the preparation of polyolefins.

It is also an object of the present invention to provide a Ziegler-Natta catalyst composition that can produce a higher porosity homopolymer matrix, which can accommodate higher rubber while co-polymerizing and is able to produce high impact grade polymer.

It is still another object of the present disclosure to provide a process for preparing a Ziegler-Natta catalyst composition.

Yet another object of the present disclosure is to provide a Ziegler-Natta catalyst composition which has a self-extinguishing character resulting in a catalyst free polymer product at the end of the polymerization reaction.

It is a further object of the present disclosure to provide a process for preparing a Ziegler-Natta catalyst composition which avoids polymer chunk formation during a gas phase polymerization reaction.

Other objects and advantages of the present disclosure will be more apparent from the following description which is not intended to limit the scope of the present disclosure.

### SUMMARY

In accordance with one aspect of the present disclosure there is provided a Ziegler-Natta catalyst composition comprising:
a. at least one pro-catalyst comprising:
   i. a morphologically modified magnesium alkoxide as a support;
   ii. at least one titanium halide;
   iii. at least one first internal donor and at least one second internal donor; and
   iv. at least one inert hydrocarbon medium,
b. at least one organo-aluminum compound as a co-catalyst; and
c. at least one external donor comprising an organo-silane compound and a carboxylic acid ester.

The catalyst can be characterized in that:
i. the molar ratio of said magnesium alkoxide to the titanium halide ranges from 1:10 to 1:20;
ii. the molar ratio of said magnesium alkoxide to the first internal donor ranges from 1:0.1 to 1:5;
iii. the molar ratio of the elemental titanium to the elemental aluminum present in organo-aluminum compound (Ti:Al) in said catalyst composition, ranges from 1:1 to 1:250; and
iv. the molar ratio of external donor to the elemental aluminum, present in said organo-aluminum compound (Si:Al) ranges from 1:1 to 1:50.

The morphologically modified magnesium alkoxide can be characterized by:
a. mean particle size in the range of 20 to 70μ;
b. surface area in the range of 1 to 30 m²/g;
C. circularity in the range of 0.5 to 0.9;
d. macro-pore size distribution in the range of 40 to 80%;
e. meso-pore size distribution in the range of 15 to 60%; and
f. micro-pore size distribution in the range of 2 to 10%.

In accordance with another aspect of the present disclosure there is provided a process for preparing a Ziegler-Natta catalyst composition, said process comprising the following steps:
a. reacting magnesium metal with at least one alcohol and at least one initiator under agitation, at a temperature of 20 to 100° C. and at a pressure of 0.1 to 5 atm. to obtain a morphologically modified magnesium alkoxide, wherein, the molar ratio of magnesium metal to alcohol ranges from 1:2 to 1:20;
b. treating said magnesium alkoxide with a titanium halide, at least one first internal donor and optionally, at least one second internal donor or organic acid chloride that in-situ generates said second internal donor at a temperature ranging from 20 to 100° C. to obtain a dispersion comprising a treated support; said titanium halide being selected from the group consisting of titanium tetrachloride, titanium tetrabromide, titanium tetraiodide and titanium tetrafluoride, preferably titanium tetrachloride; wherein the molar ratio of said magnesium alkoxide to the titanium halide ranges from 1:10 to 1:20; and the molar ratio of said magnesium alkoxide to the first internal donor ranges from 1:0.1 to 1:5;
c. adding second internal donor or organic acid chloride that in-situ generates said second internal donor to the dispersion along with a titanium halide in the presence of at least one inert hydrocarbon medium to obtain a pro-catalyst;
d. mixing the pro-catalyst with a co-catalyst comprising at least one organo-aluminum compound selected from the group consisting of triethyl aluminum, tridecyaluminum, tri-n-butyl aluminum, tri-isopropyl aluminum, tri-isoprenyl aluminum, tri-isobutyl aluminum hydride, ethyl aluminumsesquichloride, diethyl aluminum chloride, di-isobutyl aluminum chloride, triphenyl aluminum, tri-n-octyl aluminum and tri-n-decyl aluminum to obtain an activated catalyst; wherein the molar ratio of elemental titanium to elemental aluminum present in the organo-aluminum compound (Ti:Al), in said catalyst composition ranges from 1:1 to 1:250; and
e. adding to the activated catalyst, an external donor comprising an organo-silane compound selected from the group consisting of di-phenyl dimethoxy silane, phenyl tri-methoxy silane, phenyl ethyl di-methoxy silane, phenyl methyl di-methoxy silane, tri-methyl methoxy silane, iso-butyl tri-methoxy silane, di-iso-butyl methoxy silane, di-cyclo-pentyl-di-methoxy silane, di-t-butyl dimethoxy silane, di-cyclo-pentyl dimethoxy silane, cyclo-hexyl methyl di-methoxy silane and di-cyclo hexyl di-methoxy silane and at least one carboxylic acid ester to obtain the Ziegler-Natta catalyst composition; wherein the molar ratio of the external donor to the elemental aluminum (Si:Al), present in said organo-aluminum compound ranges from 1:1 to 1:50.

The method step (b) can further comprise at least one step selected from the group consisting of i. decanting the supernatant; ii. adding at least one titanium halide and at least one hydrocarbon medium; and iii. decanting to recover the hydrocarbon medium to obtain a dispersion.

The method step (a) can comprise the following steps:
a. reacting magnesium metal with at least one alcohol and at least one initiator at a temperature of 40 to 65° C., for a period of 30 min to 3 hrs. to obtain a first mass;
b. heating and maintaining the first mass at a temperature of 65 to 80° C. for a period of 30 min to 10 hrs to obtain a second mass; and
c. drying the second mass under an inert atmosphere at a temperature in the range of 60-120° C. to obtain a morphologically modified magnesium alkoxide.

The second internal donor can be at least one organic acid ester or organic acid chloride that in-situ generates said organic acid ester.

### DEFINITION

In the context of the present invention the term:—

“macro porosity” refers to a pore size greater than 50 nm in diameter.

“meso porosity” refers to pore size greater than 2 nm and less than 50 nm in diameter.

“micro porosity” refers to pore size smaller than 2 nm in diameter.

### DETAILED DESCRIPTION

Conventional Ziegler-Natta catalysts suffer from a number of drawbacks such as inadequate activity, insufficient hydrogen response and the like.

Therefore, in accordance with the present disclosure there is provided a novel Ziegler-Natta catalyst composition comprising a pro-catalyst, a co-catalyst and an external donor.

The pro-catalyst used in the Ziegler-Natta catalyst composition of the present disclosure contains a morphologically modified magnesium alkoxide as a support, titanium halide as a catalyst, at least one first internal donor, at least one second internal donor and at least one inert hydrocarbon medium. The molar ratio of the morphologically modified magnesium alkoxide to titanium halide ranges from 1:10 to 1:20 and the molar ratio of the morphologically modified magnesium alkoxide to the first internal donor ranges from 1:0.1 to 1:5.

The morphologically modified magnesium alkoxide used in the pro-catalyst of the present disclosure is characterized by mean particle size in the range of 20 to 70μ; surface area in the range of 1 to 30 m²/g; circularity in the range of 0.5 to 0.9; macro pore size distribution in the range of 40 to 80%; meso pore size distribution in the range of 15 to 60%; and micro pore size distribution in the range of 2 to 10%.

Examples of magnesium alkoxide include magnesium ethoxide, magnesium methoxide, magnesium propoxide, magnesium iso-propoxide, magnesium butoxide and magnesium iso-butoxide

The titanium halide used in the pro-catalyst of the present disclosure includes but is not limited to titanium tetrachloride, titanium tetrabromide, titanium tetraiodide, titanium tetrafluoride and combination thereof.

In accordance with one embodiment of the present disclosure the titanium halide is titanium chloride.

In accordance with one embodiment of the present disclosure the first internal donor is at least one ether and the second internal donor is at least one organic acid ester.

The first internal donor in the pro-catalyst of the present disclosure includes but is not limited to 1,3-diether selected from the group consisting of dialkyl diether, diaryl diether, alkyl aryl diether, dicycloalkyl diether, and alkyl cycloalkyl diether.

The 1,3-diether is at least one selected from the group consisting of 1,1-bis (methoxymethyl)-2,3,6,7-tetrafluoroindene; 1,1-bis (methoxymethyl)-4,7-dimethylindene; 1,1-bis (methoxymethyl)-3,6-dimethylindene; 1,1-bis (methoxymethyl)-4-phenylindene; 1,1-bis (methoxymethyl)-4-phenyl-2-methylindene; 1,1-bis (methoxymethyl)-4-cyclohexylindene; 1,1-bis (methoxymethyl)-7-(3,3,3-trifluoropropyl)indene; 1,1-bis (methoxymethyl)-7-trimethylsilylindene; 9,9-bis (methoxymethyl)-fluorene; 9,9-bis (methoxymethyl)-2,3,6,7-tetramethylfluorene; 9,9-bis (methoxymethyl)-2,3,4,5,6,7-hexafluorofluorene; 9,9-bis (methoxymethyl)-2,3-benzofluorene, 9,9-bis (methoxymethyl)-2,7-diisopropylfluorene; 9,9-bis (methoxymethyl)-2,7-dicyclopentylfluorene; 9,9-bis (1′-isopropoxy-n-butyl-4,5-diphenylfluorene; 9,9-bis (1′-methoxyethyl)fluorene; 9-methoxymethyl-9-pentoxymethylfluorene; 9-methoxymethyl-9-ethoxymethylfluorene; 9-methoxymethyl-9-(1′-methoxyethyl)-fluorene; 1,1-bis (methoxymethyl)-2,5-cyclohexadiene, 1,1-bis (methoxymethyl) benzonaphthene; 9,9-bis(methoxymethyl)-1,4-methanedihydronaphthalene; and 9,9-bis (methoxymethyl)-9,10-dihydroanthracene.

In one embodiment the first internal donor 1,3-diether is 9,9-bis(methoxymethyl)fluorene.

The pro-catalyst of the present disclosure is obtained by treatment of the first internal donor containing magnesium alkoxide precursor with a mixture of titanium tetrachloride and the second internal donor in at least one inert hydrocarbon medium during the catalyst preparation or optionally is added externally during catalyst synthesis. The second internal donor may be generated in-situ by addition of an organic acid chloride.

The externally added second internal donor is at least one ester selected from the group consisting of organic acid esters having 2 to about 30 carbon atoms such as ethyl benzoate, n-butyl benzoate, p-methoxy ethylbenzoate, p-ethoxy ethylbenzoate, isobutyl benzoate, ethyl-p-toluate, diethyl phthalate, di-n-propyl phthalate, di-n-butyl phthalate, di-n-pentyl phthalate, di-i-pentyl phthalate, his (2-ethylhexyl)phthalate, ethyl-isobutyl phthalate, ethyl-n-butyl phthalate, di-n-hexyl phthalate, and di-isobutyl phthalate.

In one embodiment the organic acid ester is ethyl benzoate.

The inert hydrocarbon medium used in the pro-catalyst of the present disclosure includes but is not limited to hexane, pentane, heptane, octane, nonane, decane, mineral oil and versol. The inert hydrocarbon medium more suitable in the pro-catalyst of the present disclosure is decane.

The co-catalyst used in accordance with the present disclosure contains one or more organo-aluminum compounds, which includes but is not limited to triethyl aluminum, tridecylaluminum, tri-n-butyl aluminum, tri-isopropyl aluminum, tri-isoprenyl aluminum, tri-isobutyl aluminum hydride, ethyl aluminumsesquichloride, diethyl aluminum chloride, di-isobutyl aluminum chloride, triphenyl aluminum, tri-n-octyl aluminum and tri-n-decyl aluminum.

The molar ratio of the elemental titanium to the elemental aluminum present in the organo-aluminum compound (Ti:Al), in the catalyst composition, ranges from 1:1 to 1:250. In accordance with one embodiment of the present disclosure the organo-aluminum compound is triethyl aluminum.

The external donor used in the Ziegler-Natta catalyst composition of the present disclosure includes organo-silane compound and carboxylic acid ester.

The organo-silane compound used in the external donor of the present disclosure includes but is not limited to di-phenyl dimethoxy silane, phenyl tri-methoxy silane, phenyl ethyl di-methoxy silane, phenyl methyl di-methoxy silane,tri-methyl methoxy silane, iso-butyl tri-methoxy silane, di-iso-butyl methoxy silane, di-cyclo-pentyl-di-methoxy silane, di-t-butyl dimethoxy silane, di-cyclo-pentyl dimethoxy silane, cyclo-hexyl methyl di-methoxy silane, di-cyclo hexyl di-methoxy silane and combinations thereof.

The carboxylic acid ester compound used in the external donor of the present disclosure includes but is not limited to of C1-4 alkyl benzoates and C1-4 ring alkylated derivatives thereof.

Typically, the carboxylic acid ester includes but is not limited to methyl benzoate, ethyl benzoate, propyl benzoate, methyl p-methoxybenzoate, methyl p-ethoxybenzoate, ethyl-p-methoxybenzoate, ethyl-p-ethoxybenzoate, p-isopropoxy ethylbenzoate and combinations thereof.

In various embodiments of the present disclosure the external donor includes ethyl benzoate, ethyl-p-ethoxybenzoate and p-isopropoxy ethyl benzoate in combination with organosilane compounds.

The molar ratio of the external donor to the elemental aluminum, present in said organo-aluminum compound (Si:Al) ranges from 1:1 to 1:50.

In accordance with the present disclosure there is also provided a process for preparing a Ziegler-Natta catalyst composition. The process involves the following steps:

In the first step, magnesium metal is reacted with at least one alcohol and at least one initiator under agitation, at a temperature of 20 to 100° C. and at a pressure of 0.1 to 5 atm. to obtain a morphologically modified magnesium alkoxide. The ratio of magnesium metal to alcohol is maintained in the range of 1:2 to 1:20.

The step of reacting magnesium metal with alcohol and initiator is typically carried out at a temperature of 40 to 65° C., for a period of 30 min. to 3 hrs. to obtain a first mass. The first mass so obtained is then heated and maintained at a temperature of 65 to 80° C. for a period of 30 min to 10 hrs to obtain a second mass and then the second mass is dried under inert atmosphere at temperature in the range of 60-120° C. to obtain a morphologically modified magnesium alkoxide. The morphologically modified magnesium alkoxide so obtained is characterized by mean particle size in the range of 20 to 70 m, surface area in the range of 1 to 30 m²/g; and porosity in the range of 0.1 to 0.4 cm³/g and circularity in the range of 0.5 to 0.9.

Pore size distribution and surface area is measured by nitrogen adsorption-desorption method by Sorptomatic 1990 instrument. Circularity is measured by image-j software.

Brunauer-Emmett-Teller (BET) method is used for Surface Area Analysis and Barrett-Joyner-Halenda (BJH) method is used for Pore Size distribution.

The alcohol used in accordance with the present disclosure includes but is not limited to methanol, ethanol, propanol, isopropanol, butanol, isobutanol and combinations thereof. The initiator used in the present disclosure includes but is not limited to titanium tetrachloride and magnesium dichloride.

In the second step, the morphologically modified magnesium alkoxide so obtained is used as a support and is treated with titanium halide, at least one first internal donor and optionally, at least one second internal donor or organic acid chloride that is capable of providing the second internal donor during the course of treatment at a temperature ranging from 20 to 120° C. to obtain a dispersion comprising a treated support. The dispersion is optionally, kept for settling and then the hydrocarbon medium is decanted.

The dispersion thus obtained is optionally contacted with titanium halide and hydrocarbon medium, and the excess of hydrocarbon medium is decanted to obtain a mixture.

In the third step, the mixture or the dispersion is then treated with titanium halide and the at least one second internal donor or organic acid chloride that is capable of providing the second internal donor during the course of the treatment in the presence of at least one inert hydrocarbon medium to obtain a pro-catalyst.

The organic acid chloride used for in-situ generation of a second donor includes but is not limited to benzoyl chloride, p-methoxy benzoyl chloride, p-ethoxy benzoyl chloride, p-methyl benzoyl chloride and phthaloyl chloride.

In the fourth step, the pro-catalyst is mixed with a co-catalyst to obtain an activated catalyst.

The molar ratio of elemental titanium to elemental aluminium present in the co-catalyst (Ti:Al) of said catalyst composition, ranges from 1:1 to 1:250.

In the fifth step, the activated catalyst is contacted with an external donor to obtain the Ziegler-Natta catalyst composition. The molar ratio of the external donor to the elemental aluminum (Si: Al), present in said organo-aluminum compound ranges from 1:1 to 1:50.

The external donor includes one or more organo-silane compounds and one or more carboxylic acid ester compounds.

The present disclosure is further described in the light of the following examples which are set forth for illustration purpose only and not to be construed for limiting the scope of the disclosure.

### Example 1

Preparation of Ziegler-Natta Catalyst Composition

Step 1A: Preparation of the Morphologically Modified Magnesium Ethoxide Using Titanium Tetrachloride.

0.41 moles of magnesium was reacted with 4 moles of ethanol in the presence of 0.0027 moles of TiCl₄. The temperature of the obtained mass was increased to 60° C. for completion of the reaction to obtain magnesium ethoxide which dried at 100° C. under nitrogen to obtain 0.41 moles (48 gm) of magnesium ethoxide.

Step 1B: Preparation of the Morphologically Modified Magnesium Ethoxide Using Magnesium Dichloride

0.41 moles of magnesium was reacted with 4.0 moles of ethanol in the presence of 0.0212 moles of magnesium dichloride at a temperature of 65° C., for a period of 3 hrs to obtain a first mass. The first mass so obtained was then heated at a temperature 80° C. for a period of 2 hrs to obtain a second mass and then the second mass was maintained at a temperature of 80° C. for a period of 10 hrs followed by drying at 80° C. temperature under nitrogen to obtain 0.41 moles (48 gm) of magnesium ethoxide.

Step 2:

0.087 mole of magnesium ethoxide prepared in example step 1A was mixed with 1.05 mole of TiCl₄ and equivolume chlorobenzene at a temperature of 20° C., and then 0.0177 moles of 9,9-bis (methoxymethyl)-fluorene was added to obtain dispersion containing treated magnesium ethoxide.

After completion of the reaction, excess of TiCl₄ and chlorobenzene were decanted. Again equi-volume mixture of TiCl₄ and chlorobenzene was added and allowed to react at the same temperature condition, and decanted after completion of the reaction. Similar volume of TiCl₄ and chlorobenzene along with 0.004 mole of benzoyl chloride was added in the mixture to obtain a pro-catalyst. (In this step, ethyl benzoate formed in-situ which acts as second internal donor) 70 mg of pro-catalyst having 0.0393 mmol Titanium was then mixed with 9.8 mmol triethyl aluminum co-catalyst to obtain an activated catalyst. The activated catalyst so prepared was contacted with mixed external donor, in the molar ratio of 1:5.0, comprising organo-silane compound and carboxylic acid ester to obtain the Ziegler-Natta catalyst composition as shown in Table-1 as CAT-1.

### Example 2

Preparation of Ziegler-Natta Catalyst Composition

0.41 moles of magnesium was reacted with 4 moles of ethanol in the presence of 0.0027 mole of TiCl4. Other steps were followed as per example −1 to obtain the Ziegler-Natta catalyst composition i.e., CAT-2 and compared with catalyst i.e., CAT-3 prepared using iodine as an initiator.

TABLE 1
Catalyst compositions obtained by different processes

| | | | | | In-situ | | |
|---|---|---|---|---|---|---|---|
| | | | | | generated | | |
| | | | | 9, 9-bis | ethyl | | |
| | Ti, | Mg, | | (mehoxymethyl) | benzoate, | Silane, | TEAL, |
| | Wt %. | Wt % | Cl, Wt % | fluorene, wt % | wt % | mmol | mmol |
| CAT-1 | 2.5 | 16.1 | 49.8 | 14.7 | <1.0% | 2.0 | 9.9 |
| CAT-2 | 2.2 | 17.5 | 43.7 | 13.2 | <1.0% | 1.7 | 8.4 |
| CAT-3 | 2.5 | 14.0 | 48.9 | 16.0 | <1.0% | 1.7 | 8.4 |

The above catalysts were used for propylene polymerization. The Ziegler-Natta catalyst composition so prepared was charged into the reactor. Then a fixed volume of chain terminating agent (CTA) i.e. 240 ml hydrogen was charged. The polymerization reaction was carried out at 70° C. and 5 Kg/cm² pressure and allowed to react till completion of the reaction. The resultant polypropylene was isolated and dried. The characteristics of the obtained polypropylene and the catalyst used therein are shown in table-2.

TABLE 2
Comparative performance of the catalyst and
properties of the resultant polypropylene.

| | CAT-1 | CAT-2 | CAT-3 |
|---|---|---|---|
| | (Present | (Present | (comparative |
| | disclosure) | disclosure) | catalyst) |
| Catalyst Activity, | 8.7 | 8.9 | 7.7 |
| KgPP/gcat | | | |
| Hydrogen Response | 6.9 | 4.9 | 4.4 |
| (MFI), dg/min | | | |
| Stereo-regularity by | 98.6 | 98.5 | 92.9 |
| NMR, Wt. % | | | |
| Product fines, Wt. % | 5.1 | 5.7 | 7.8 |
| Resin Porosity by DOP, | 0.25 | 0.20 | 0.17 |
| ml/gm | | | |

From the above Table 2 it can be seen that the catalyst of the present invention exhibits enhanced characteristic properties as compared to those of the comparative catalyst CAT-3.

Technical Advancement and Economic Significance:

The present disclosure has the following advantages:
The catalyst composition is capable of controlling the reaction kinetics of an olefin polymerization reaction.
The catalyst composition has a higher activity.
The catalyst composition has a higher hydrogen response and can produce a polymer with high MFI (melt flow index), of up to 100 gm/10 mins
The catalyst composition has a self-extinguishing character resulting in a catalyst free polymer product at the end of the polymerization reaction.
The catalyst composition may be used for the preparation of high rubber impact co-polymers, where high porosity homopolymer matrix is desired.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the invention to achieve one or more of the desired objects or results.

The numerical values given for various physical parameters, dimensions and quantities are only approximate values and it is envisaged that the values higher than the numerical value assigned to the physical parameters, dimensions and quantities fall within the scope of the invention and the claims unless there is a statement in the specification to the contrary.

While certain embodiments of the inventions have been described, these embodiments have been presented by way of example only, and are not intended to limit the scope of the inventions. Variations or modifications in the process or compound or formulation or combination of this invention, within the scope of the invention, may occur to those skilled in the art upon reviewing the disclosure herein. Such variations or modifications are well within the spirit of this invention. The accompanying claims and their equivalents are intended to cover such forms or modifications as would fall within the scope and spirit of the invention.

1.-26. (canceled)

27. A Ziegler-Natta catalyst composition comprising:
a. at least one pro-catalyst comprising:
i. a morphologically modified magnesium alkoxide as a support;
ii. at least one titanium halide;
iii. at least one first internal donor and at least one second internal donor; and
iv. at least one inert hydrocarbon medium,
b. at least one organo-aluminum compound as a co-catalyst; and
c. at least one external donor comprising an organo-silane compound and a carboxylic acid ester.

28. The Ziegler-Natta catalyst composition as claimed in claim 1, wherein said catalyst is characterized in that:
i. the molar ratio of said magnesium alkoxide to the titanium halide ranges from 1:10 to 1:20;
ii. the molar ratio of said magnesium alkoxide to the first internal donor ranges from 1:0.1 to 1:5;
iii. the molar ratio of the elemental titanium to the elemental aluminum, present in said organo-aluminum compound (Ti: Al) in said catalyst composition, ranges from 1:1 to 1:250; and
iv. the molar ratio of external donor to the elemental aluminum, present in said organo-aluminum compound (Si: Al) ranges from 1:1 to 1:50.

29. The catalyst composition as claimed in claim 1, wherein said morphologically modified magnesium alkoxide is characterized by:
a. mean particle size in the range of 20 to 70μ;
b. surface area in the range of 1 to 30 m²/g;
c. circularity in the range of 0.5 to 0.9;
d. macro-pore size distribution in the range of 40 to 80%;
e. meso-pore size distribution in the range of 15 to 60%; and
f. micro-pore size distribution in the range of 2 to 10%.

30. The catalyst composition as claimed in claim 1, wherein the magnesium alkoxide is at least one selected from the group consisting of magnesium ethoxide, magnesium methoxide, magnesium propoxide, magnesium iso-propoxide, magnesium butoxide and magnesium iso-butoxide; and the titanium halide is at least one selected from the group consisting of titanium tetrachloride, titanium tetrabromide, titanium tetraiodide and titanium tetrafluoride.

31. The catalyst composition as claimed in claim 1, wherein the first internal donor is at least one ether, preferably, 1,3-diether selected from the group consisting of dialkyl diether, diaryl diether, alkyl aryl diether, dicycloalkyl diether, and alkyl cycloalkyl diether.

32. The catalyst composition as claimed in claim 5, wherein the first internal donor 1,3-diether is at least one selected from the group consisting of 1,1-bis (methoxymethyl)-2,3,6,7-tetrafluoroindene; 1,1-bis(methoxymethyl)-4,7-dimethylindene; 1,1-bis (methoxymethyl)-3,6-dimethylindene; 1,1-bis (methoxymethyl)-4-phenylindene; 1,1-bis (methoxymethyl)-4-phenyl-2-methylindene; 1,1-bis (methoxymethyl)-4-cyclohexylindene; 1,1-bis (methoxymethyl)-7-(3,3,3-trifluoropropyl)indene; 1,1-bis (methoxymethyl)-7-trimethylsilylindene; 9,9-bis (methoxymethyl)-fluorene; 9,9-bis (methoxymethyl)-2,3,6,7-tetramethylfluorene; 9,9-bis (methoxymethyl)-2,3,4,5,6,7-hexafluorofluorene; 9,9-bis (methoxymethyl)-2,3-benzofluorene, 9,9-bis (methoxymethyl)-2,7-dii sopropylfluorene; 9,9-bis (methoxymethyl)-2,7-dicyclopentylfluorene; 9,9-bis (1′-isopropoxy-n-butyl-4,5-diphenylfluorene; 9,9-bis (1′-methoxyethyl)fluorene; 9-methoxymethyl-9-pentoxymethylfluorene; 9-methoxymethyl-9-ethoxymethylfluorene; 9-methoxymethyl-9-(1′-methoxyethyl)-fluorene; 1,1-bis (methoxymethyl)-2,5-cyclohexadiene, 1,1-bis (methoxymethyl) benzonaphthene; 9,9-bis(methoxymethyl)-1,4-methane dihydronaphthalene; and 9,9-bis(methoxymethyl)-9,10-dihydroanthracene.

33. The catalyst composition as claimed in claim 5, wherein the first internal donor 1,3-diether is 9,9-bis(methoxymethyl)fluorene.

34. The catalyst composition as claimed in claim 1, wherein the procatalyst is obtained by treatment of the first internal donor containing magnesium alkoxide precursor with a mixture of titanium tetrahalide and the second internal donor or organic acid chloride that in-situ generates said second internal donor.

35. The catalyst composition as claimed in claim 1, wherein the second internal donor is at least one ester selected from the group consisting of organic acid esters having 2 to about 30 carbon atoms.

36. The catalyst composition as claimed in claim 9, wherein the organic acid ester is selected from the group consisting of ethyl benzoate, n-butyl benzoate, p-methoxy ethylbenzoate, p-ethoxy ethylbenzoate, iso-butyl benzoate, ethyl p-toluate, diethyl phthalate, di-n-propyl phthalate, di-n-butyl phthalate, di-n-pentyl phthalate, di-i-pentyl phthalate, bis (2-ethylhexyl)phthalate, ethyl isobutyl phthalate, ethyl-n-butyl phthalate, di-n-hexyl phthalate, and di-iso-butyl phthalate.

37. The catalyst composition as claimed in claim 1, wherein said organo-aluminum compound is at least one selected from the group consisting of triethyl aluminum, tridecyaluminum, tri-n-butyl aluminum, tri-isopropyl aluminum, tri-isoprenyl aluminum, tri-isobutyl aluminum hydride, ethyl aluminumsesquichloride, diethyl aluminum chloride, di-isobutyl aluminum chloride, triphenyl aluminum, tri-n-octyl aluminum and tri-n-decyl aluminum.

38. The catalyst composition as claimed in claim 1, wherein the organo-silane compound is at least one selected from the group consisting of di-phenyl dimethoxy silane, phenyl tri-methoxy silane, phenyl ethyl di-methoxy silane, phenyl methyl di-methoxy silane,tri-methyl methoxy silane, iso-butyl tri-methoxy silane, di-iso-butyl methoxy silane, di-cyclo-pentyl-di-methoxy silane, di-t-butyl dimethoxy silane, di-cyclo-pentyl dimethoxy silane, cyclo-hexyl methyl di-methoxy silane and di-cyclo hexyl di-methoxy silane.

39. The catalyst composition as claimed in claim 1, wherein the carboxylic acid ester is at least one selected from the group consisting of C1-4 alkyl benzoates and C1-4 ring alkylated derivatives thereof, selected from the group consisting of methyl benzoate, ethyl benzoate, propyl benzoate, methyl p-methoxybenzoate, methyl p-ethoxybenzoate, ethyl p-methoxybenzoate, ethyl p-ethoxybenzoate and p-iso propoxy ethyl benzoate; preferably, ethyl benzoate, ethyl p-ethoxybenzoate, and p-iso propoxy ethyl benzoate.

40. The catalyst composition as claimed in claim 1, wherein the hydrocarbon medium is at least one selected from the group consisting of hexane, pentane, heptane, octane, nonane, decane, mineral oil and varsol.

41. A process for preparing a Ziegler-Natta catalyst composition, said process comprising the following steps:
a. reacting magnesium metal with at least one alcohol and at least one initiator under agitation, at a temperature of 20 to 100° C. and at a pressure of 0.1 to 5 atm. to obtain a morphologically modified magnesium alkoxide, wherein, the molar ratio of magnesium metal to alcohol ranges from 1:2 to 1:20;
b. treating said magnesium alkoxide with a titanium halide, at least one first internal donor and optionally, at least one second internal donor or organic acid chloride that in-situ generates said second internal donor at a temperature ranging from 20 to 100° C. to obtain a dispersion comprising a treated support; said titanium halide being selected from the group consisting of titanium tetrachloride, titanium tetrabromide, titanium tetraiodide and titanium tetrafluoride, preferably titanium tetrachloride; wherein the molar ratio of said magnesium alkoxide to the titanium halide ranges from 1:10 to 1:20; and the molar ratio of said magnesium alkoxide to the first internal donor ranges from 1:0.1 to 1:5;
c. adding second internal donor or organic acid chloride that in-situ generates said second internal donor to the dispersion along with a titanium halide in the presence of at least one inert hydrocarbon medium to obtain a pro-catalyst;
d. mixing the pro-catalyst with a co-catalyst comprising at least one organo-aluminum compound selected from the group consisting of triethyl aluminum, tridecyaluminum, tri-n-butyl aluminum, tri-isopropyl aluminum, tri-isoprenyl aluminum, tri-isobutyl aluminum hydride, ethyl aluminumsesquichloride, diethyl aluminum chloride, di-isobutyl aluminum chloride, triphenyl aluminum, tri-n-octyl aluminum and tri-n-decyl aluminum to obtain an activated catalyst; wherein the molar ratio of elemental titanium to elemental aluminum, present in said organo-aluminum compound (Ti:Al), present in said catalyst composition ranges from 1:1 to 1:250; and
e. adding to the activated catalyst, an external donor comprising an organo-silane compound selected from the group consisting of di-phenyl dimethoxy silane, phenyl tri-methoxy silane, phenyl ethyl di-methoxy silane, phenyl methyl di-methoxy silane,tri-methyl methoxy silane, iso-butyl tri-methoxy silane, di-iso-butyl methoxy silane, di-cyclo-pentyl-di-methoxy silane, di-t-butyl dimethoxy silane, di-cyclo-pentyl dimethoxy silane, cyclo-hexyl methyl di-methoxy silane and di-cyclo hexyl di-methoxy silane and at least one carboxylic acid ester to obtain the Ziegler-Natta catalyst composition; wherein the molar ratio of external donor to the elemental aluminum (Si:Al), present in said organo-aluminum compound ranges from 1:1 to 1:50.

42. The process as claimed in claim 15, wherein the method step (b) further comprises at least one step selected from the group consisting of i. decanting the supernatant; ii. adding at least one titanium halide and at least one hydrocarbon medium; and iii. decanting to recover the hydrocarbon medium to obtain a dispersion.

43. The process as claimed in claim 15, wherein the method step (a) comprises the following steps:
a. reacting magnesium metal with at least one alcohol and at least one initiator at a temperature of 40 to 65° C., for a period of 30 min. to 3 hrs. to obtain a first mass;
b. heating and maintaining the first mass at a temperature of 65 to 80° C. for a period of 30 min. to 10 hrs to obtain a second mass; and
c. drying the second mass under inert atmosphere at temperature in the range of 60 to 120° C. to obtain a morphologically modified magnesium alkoxide.

44. The process as claimed in claim 15, wherein the alcohol is at least one selected from the group consisting of methanol, ethanol, propanol, isopropanol, butanol and isobutanol; and the magnesium alkoxide is at least one selected from the group consisting of magnesium ethoxide, magnesium methoxide, magnesium propoxide, magnesium iso-propoxide, magnesium butoxide and magnesium iso-butoxide and wherein said initiator is at least one selected form the group consisting of titanium tetrachloride and magnesium dichloride.

45. The process as claimed in claim 15, wherein the second internal donor is at least one organic acid ester or organic acid chloride that in-situ generates said organic acid ester.

46. The process as claimed in claim 15, wherein
the second internal donor is at least one ester selected from the group consisting of organic acid esters having 2 to about 30 carbon atoms; and
the organic acid chloride that in-situ generates said second internal donor is selected from the group consisting of benzoyl chloride, p-methoxy benzoyl chloride, p-ethoxy benzoyl chloride, p-methyl benzoyl chloride and phthaloyl chloride.
